(19) United States
(12) Patent Application Publication
(10) Pub. No.: US 2014/0089510 A1
(43) Pub. Date: Mar. 27, 2014

(54) JOINT ALLOCATION OF CLOUD AND NETWORK RESOURCES IN A DISTRIBUTED CLOUD SYSTEM

(71) Applicants: Fang Hao, Morganville, NJ (US); Murali Kodialam, Marlboro, NJ (US); Tirunell V. Lakshman, Morganville, NJ (US); Sarit Mukherjee, Morganville, NJ (US)

(72) Inventors: Fang Hao, Morganville, NJ (US); Murali Kodialam, Marlboro, NJ (US); Tirunell V. Lakshman, Morganville, NJ (US); Sarit Mukherjee, Morganville, NJ (US)

(21) Appl. No.: 13/628,421

(22) Filed: Sep. 27, 2012

(51) Int. Cl. G06F 15/173

(52) U.S. Cl. 709/226

(57) ABSTRACT

A capability is provided for allocating cloud and network resources in a distributed cloud system including a plurality of data centers. A request for resources is received. The request for resources includes a request for cloud resources and an indication of an amount of cloud resources requested. The request for resources also may include a request for network resources or one or more constraints. A set of feasible resource mappings is determined based on the request for resources and information associated with the distributed cloud system. A resource mapping to use for the request for resources is selected from the set of feasible resource mappings. The selected resource mapping includes a mapping of the requested cloud resources to cloud resources of one or more of the data centers and an identification of network resources configured to support communications for the cloud resources of the one or more data centers.

### TECHNICAL FIELD

The disclosure relates generally to communication networks and, more specifically but not exclusively, to allocation of resources in a distributed cloud system.

### BACKGROUND

Many cloud operators currently host cloud services using centralized cloud systems as opposed to distributed cloud systems, although some cloud operators are beginning to provide cloud services using distributed cloud systems. In general, a centralized cloud system typically includes less data centers than a distributed cloud system, and the data centers of a centralized cloud system are typically larger than the data centers of a distributed cloud system. The use of a distributed cloud system, as opposed to a centralized cloud system, may be economically feasible for some service providers, such as for service providers that already have existing facilities distributed across wide areas (e.g., Central Offices of network providers that already have a large base of existing infrastructure).

In such centralized cloud systems, a requester may request the use of one or more resources from a cloud operator and the cloud operator may then allocate the requested resources from one of the data centers for use by the requestor. The use of a centralized cloud system, however, while suitable for exploiting the economic benefit of large scales, tends to introduce limitations such as increased latency experienced by users and potential reliability issues. While the use of a distributed cloud system, as opposed to a centralized cloud system, may reduce the latency experienced by users, allocation of resources to a requester in a distributed cloud system generally is more complicated than allocation of resources to a requester in a centralized cloud system.

### SUMMARY OF EMBODIMENTS

Various deficiencies in the prior art are addressed by embodiments for allocating resources in a distributed cloud system including a plurality of data centers.

In at least some embodiments, an apparatus includes a processor and a memory communicatively connected to the processor, where the processor is configured to receive a request for resources of the distributed cloud system and determine a resource mapping for the request for resources based on the request for resources and information associated with the distributed cloud system. The request for resources includes a request for cloud resources and an indication of an amount of cloud resources requested. The resource mapping includes a mapping of the requested cloud resources to cloud resources of one or more of the data centers and an identification of network resources configured to support communications for the cloud resources of the one or more data centers.

In at least some embodiments, a computer-readable storage medium stores instructions which, when executed by a computer, cause the computer to perform a method that includes receiving a request for resources of the distributed cloud system and determining a resource mapping for the request for resources based on the request for resources and information associated with the distributed cloud system. The request for resources includes a request for cloud resources and an indication of an amount of cloud resources requested. The resource mapping includes a mapping of the requested cloud resources to cloud resources of one or more of the data centers and an identification of network resources configured to support communications for the cloud resources of the one or more data centers.

In at least some embodiments, a method includes using a processor for receiving a request for resources of the distributed cloud system and determining a resource mapping for the request for resources based on the request for resources and information associated with the distributed cloud system. The request for resources includes a request for cloud resources and an indication of an amount of cloud resources requested. The resource mapping includes a mapping of the requested cloud resources to cloud resources of one or more of the data centers and an identification of network resources configured to support communications for the cloud resources of the one or more data centers.

### BRIEF DESCRIPTION OF THE DRAWINGS

The teachings herein can be readily understood by considering the following detailed description in conjunction with the accompanying drawings, in which:

FIG. 1 depicts a high-level block diagram of a distributed cloud system including a resource allocation system;

FIG. 2 depicts one embodiment of a method for determining resource mappings in response to resource requests in a distributed cloud system;

FIG. 3 depicts one embodiment of a method for determining a resource mapping in response to a resource request in a distributed cloud system; and

FIG. 4 depicts a high-level block diagram of a computer suitable for use in performing functions described herein.

To facilitate understanding, identical reference numerals have been used, where possible, to designate identical elements that are common to the figures.

### DETAILED DESCRIPTION OF EMBODIMENTS

In general, a resource allocation capability is provided for performing joint allocation of cloud resource and network resources in a distributed cloud system including a plurality of data centers.

In at least some embodiments, the resource allocation capability is configured to determine allocation of cloud resources (e.g., computing, memory, storage, or the like) and network resources (e.g., bandwidth or the like) in response to a request for cloud resources (and, optionally, network resources) in a distributed cloud system including a plurality of data centers. In at least some embodiments, the resource allocation capability may determine allocation of cloud resources and network resources for the resource request based on the resource request (e.g., the type or types of resources indicated, the quantity or quantities of resources indicated, one or more user constraints, or the like) and information associated with the distributed cloud system. In at least some embodiments, the resource allocation capability may determine allocation of cloud resources and network resources for a resource request based on one or more of characteristics of available resources (e.g., characteristics of data centers, characteristics of cloud resources of data centers, characteristics of network connectivity within data centers, characteristics of network connectivity between data centers, or the like), one or more user constraints (e.g., the geographic location(s) of the cloud resources, network latency bounds for the user, or the like), one or more objectives of the cloud provider (e.g., balancing the load, maximizing the revenue, or the like), or the like, as well as various combinations thereof.

It will be appreciated that, although primarily depicted and described with respect to use of the resource allocation capability within the context of a specific type of system (namely, a distributed cloud system), the resource allocation capability also may be used within the context of other suitable types of systems.

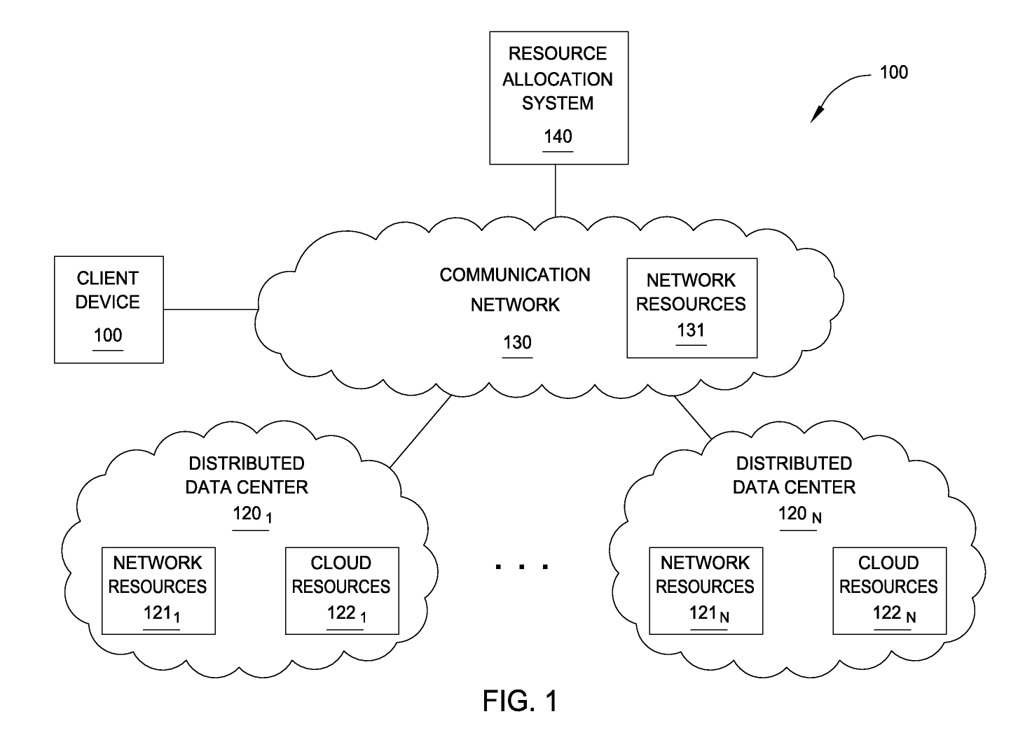

FIG. 1 depicts a high-level block diagram of a distributed cloud system including a resource allocation system.

The distributed cloud system 100 includes a client device 110, a plurality of distributed data centers 120₁-120_{N} (collectively, distributed data centers 120), a communication network 130, and a resource allocation system 140.

The distributed data centers 120 and the communication network 130 cooperate to provide a distributed cloud system. The distributed cloud system may be used by client device 110 or one or more other client devices (omitted for purposes of clarity). The distributed cloud system may support one or more cloud services (e.g., cloud-based applications, cloud-based file systems, virtual resources, or the like, as well as various combinations thereof) which may be used by client device 110 or one or more other client devices. The distributed cloud system may be operated by a cloud provider, which may be a network service provider (e.g., a provider that has direct control over communication network 130), a cloud service provider (e.g., a provider that does not have direct control over communication network 130), or the like. The typical configuration and operation of a distributed cloud system will be understood by one skilled in the art.

The client device 110 may be configured to request an allocation of resources of the distributed cloud system provided by the distributed data centers 120 and the communication network 130. The client device 110 may be configured to direct the request for the allocation of resources of the distributed cloud system to the resource allocation system 140. The client device 110 may request an allocation of resources to be used by client device 110 or one or more other client devices which may be associated with any of the distributed data centers 120 or the communication network 130 (which are omitted for purposes of clarity). For example, client device 110 may be a desktop computer, a laptop computer, a tablet computer, a smart phone, a server, a server blade, or any other type of device configured to request an allocation of resources of a distributed cloud system.

The distributed data centers 120 are distributed geographically. The distributed data centers 120 may be located at any suitable geographic locations. The distributed data centers 120 may be distributed across a geographic area of any suitable size (e.g., globally, on a particular continent, within a particular country, within a particular portion of a country, or the like). The distributed data centers 120 are expected to be located relatively close to the users (where the user devices expected to access the distributed data centers 120 have been omitted for purposes of clarity). For example, where the cloud provider may be a network service provider, at least a portion of the distributed data centers 120 may be implemented within Central Offices (COs) of the network service provider. It will be understood that, as traditional telecommunications equipment deployed in the COs has become more compact, real estate has become available at the COs and may be used for deployment of servers configured to operate as part of a distributed cloud system. It also will be understood that such COs generally tend to be highly networked, such that they may be configured to support the additional traffic associated with a distributed cloud system.

The distributed data centers 120 each include network resources 121 (illustratively, network resources 121₁-121_{N} of distributed data centers 120₁-120_{N}, respectively). The network resources 121 of a distributed data center 120 may include network resources configured to support communications within the distributed data center 120 (e.g., between VMs within the distributed data center) as well as between elements of the distributed data center (e.g., VMs) and elements located outside of the distributed data center 120. For example, the network resources 121 of a distributed data center 120 may include network elements (e.g., host servers, top-of-rack switches, aggregating switches, routers, or the like), communication links, or the like, as well as various combinations thereof. The network resources 121 also may include network resources which may be requested by a user and which may be allocated for use in supporting communications of the distributed data center 120 (e.g., bandwidth or other suitable types of network resources).

The distributed data centers 120 each include cloud resources 122 (illustratively, cloud resources 122₁-122_{N} of distributed data centers 120₁-120_{N}, respectively). The cloud resources 122 each may include one or more of computing resources, memory resources, storage resources, or the like, as well as various combinations thereof. For example, the cloud resources 122 may support Virtual Machines (VMs), cloud-based file systems, cloud-based applications, or the like, as well as various combinations thereof. The types of cloud resources 122 which may be made available from a distributed data center 120, as well as the various potential uses of such cloud resources 122, will be understood by one skilled in the art.

The distributed data centers 120 are configured to communicate with each other via communication network 130. The distributed data centers 120 may communicate with each other for purposes of supporting one or more cloud services utilized by client device 110 or one or more other client devices. For example, virtual machines (VMs) instantiated in distributed data centers 120 may communicate with each other for purposes of exchanging information related to one or more cloud services being used by a user for which the VMs are instantiated.

The communication network 130 supports communication between various elements of the distributed cloud system (e.g., between the distributed data centers 120, including between cloud resources 122 of the distributed data centers 120). The communication network 130 includes network resources 131. The network resources 131 may include network resources configured to support communication between the distributed data centers 120 (e.g., between the cloud resources 122 of the distributed data centers 120). For example, the network resources 131 may include network elements, communication links, or the like, as well as various combinations thereof. The network resources 131 also may include network resources which may be requested by a user and which may be allocated for use in supporting communication between cloud resources 122 allocated to the user (e.g., bandwidth or other suitable types of network resources).

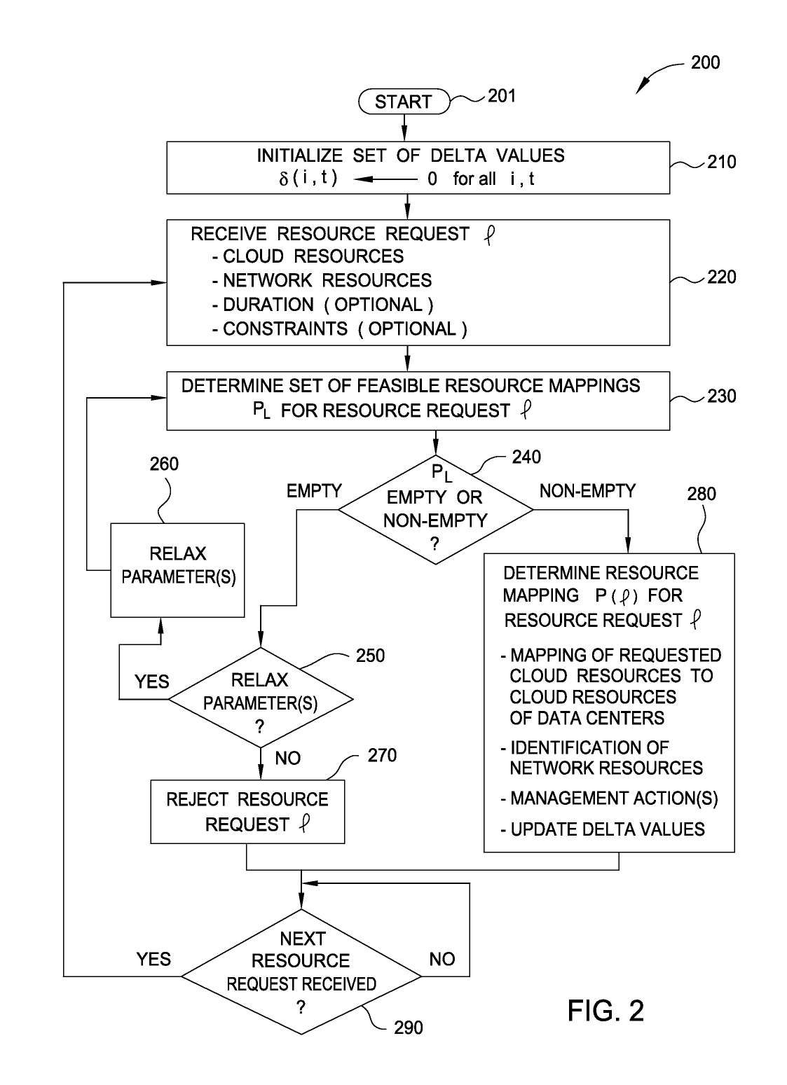

The resource allocation system 140 may be configured to receive a resource request from client device 110 and determine a resource allocation in response to the resource request received from client device 110. The resource request received from client device 110 specifies cloud resources (e.g., the amount of cloud resources 122, the location(s) of cloud resources 122, or the like) requested by the client device 110 and, optionally, network resources (e.g., bandwidth or other types of network resources) requested by the client device 110. The resource allocation system 140 may be configured to determine a resource allocation based on the resource request from client device 110 (e.g., the type or types of resources indicated, the quantity or quantities of resources indicated, one or more user constraints, or the like) and information associated with the distributed cloud system 100, where the information associated with the distributed cloud system 100 may include one or more of indications of cloud resources 122 and network resources 121 available at each of at least a portion of the distributed data centers 120, indications of network resources 131 of the communication network 130 that are available to support communications between ones of the distributed data centers 120, or the like, as well as various combinations thereof. The resource allocation system 140 may be configured to determine a resource allocation based on the resource request from client device 110 while based on one or more of characteristics of available resources (e.g., characteristics of data centers, characteristics of cloud resources of data centers, characteristics of network connectivity within data centers, characteristics of network connectivity between data centers, or the like), one or more user constraints (e.g., the geographic location(s) of the cloud resources, network latency bounds for the user, or the like), one or more objectives of the cloud provider (e.g., balancing the load, maximizing the revenue, or the like), or the like, as well as various combinations thereof. The operation of the resource allocation system 140 in determining a resource allocation based on a resource request from client device 110 may be better understood by way of reference to FIG. 2. The resource allocation system 140 also may be configured provide a resource allocation response to client device 110.

The resource allocation system 140 may be configured to control provisioning of resources based on the resource allocation that is determined by the resource allocation system 140 in response to the resource request from the client device 110. The resource allocation system 140 may be configured to communicate with one or more of the distributed data centers 120 for controlling allocation of cloud resources 122 based on the resource allocation that is determined by the resource allocation system 140. The resource allocation system 140 may be configured to communicate with one or more elements of the communication network 130 for controlling allocation of network resources 131 based on the resource allocation that is determined by the resource allocation system 140 (e.g., provisioning bandwidth between various ones of the distributed data centers).

The resource allocation system 140 may be configured to determine joint allocation of cloud resources 122 and network resources 131 in the distributed cloud system provided by distributed data centers 120 and communication network 130. The problem of determining joint allocation of cloud resources 122 and network resources 131 in a distributed cloud system may be better understood by first considering a formal problem definition for determining joint allocation of cloud resources 122 and network resources 131 in a distributed cloud system.

The resource allocation system 140 may be configured to represent the distributed cloud system as a time slotted system that includes n resources. The time slots may be indexed by t, the resources may be indexed by i, and B(i,t) may represent the amount of resource i available in time slot t. The time slots indexed by t may use any suitable increments of time (e.g., seconds, minutes, hours, days, or the like). The resources indexed by i may include any types of resources that may be supported by the distributed cloud system and that may be specified as part of a resource request, including cloud resources (e.g., VMs, storage capacity, or the like) and network resources (e.g., bandwidth or the like). The values of B(i,t) may be assumed to be known to the resource allocation system 140.

The resource allocation system 140 may be configured to receive resource requests, which may be indexed by l. A resource request l specifies the amount of resources i requested in each time slot t, the duration T(l) for which the resources i will be used, and, optionally, a set of constraints to be satisfied. The requested resources include one or more types of cloud resources (e.g., VMs, storage, or the like) and one or more types of network resources (e.g., bandwidth or the like). The amount of resources i includes, for each type of resource being requested, the requested amount of the type of resource being requested (e.g., ten VMs, 1 GB of storage capacity, 1 Mbps of bandwidth between data centers, or the like). The duration T(l) for which the resources i will be used may be specified in increments of the time slots t. The set of constraints may include one or more of the location(s) at which the requested resources i may be provided (e.g., which may be specified as geographic locations or areas, identification of distributed data centers 120, or the like), interconnection requirements related to interconnection of the requested resources i at the specified location(s), latency requirements, or the like, as well as various combinations thereof.

The resource allocation system 140 may be configured to represent the resource allocation decision for request l as a resource mapping P of the resource request l to resources of the distributed cloud system (e.g., cloud resources 122 and network resources 131). In general, in order for a resource mapping P to be feasible, there needs to be (1) sufficient cloud resources 122 available at the distributed data centers 120 to which the cloud resources 122 are mapped and (2) sufficient network resources 131 to support communication requirements for communications between distributed data centers 120 to which the cloud resources 122 are mapped as well as between distributed data centers 120 to which the cloud resources 122 are mapped and end nodes which will be using the resource allocation in the distributed cloud system. Letting Pₗ denote a set of feasible resource mappings P for resource request l and letting A(l,P,i,t) for resource request l denote the total amount of resources i consumed in time slot t when resource mapping P is used, it will be appreciated that, in order for the resource mapping P to be feasible, then A(l,P,i,t) must be less than the residual amount of resources i available during time period t (e.g., there must be sufficient resources available to support the proposed resource allocation).

The resource allocation system 140 may be configured to determine joint allocation of cloud resources 122 and network resources 131 by determining, for each time period t, a valid resource mapping P that at least satisfies a total revenue threshold and, in at least some cases, that maximizes the total revenue. The value r(l) represent the amount of revenue generated if resource request l is accepted into the distributed cloud system. Let X_{P}^{l}=1 if the resource mapping PεPₗ is used for resource request l, and zero otherwise. In this case, the problem of maximizing the number of resources can be expressed as:

$$\begin{matrix}max {\sum }_{𝓁}^{ } r ( 𝓁 ) {\sum }_{P ∈ {P}_{𝓁}}^{ } {X}_{P}^{𝓁} , \\ where \text{:} & ( Eq . 1 ) \\ {\sum }_{P ∈ {P}_{𝓁}}^{ } {X}_{P}^{𝓁} \leq 1 ∀ 𝓁 , \\ & ( Eq . 1.1 ) \\ {{\sum }_{𝓁 \text{:} T ( 𝓁 ) ∋ t}}^{ } {\sum }_{P ∈ {P}_{𝓁}}^{ } A ( 𝓁 , P , i , t ) {X}_{P}^{𝓁} \leq B ( i , t ) ∀ i ∀ t , \\ and & ( Eq . 1.2 ) \\ {X}_{P}^{𝓁} ∈ \{ 0 , 1 \} ∀ i , t . & ( Eq . 1.3 )\end{matrix}$$

Equation 1.1 ensures that, at most, one resource mapping P is used in each time slot. Note that if Σ_{PεP}_{ₗ}X_{P}^{l}=0 then the resource request l is rejected.
Equation 1.2 enforces the capacity constraint for each resource i in each time slot t. Next, consider the linear programming (LP) relaxation of the above problem, in which 0≦X_{P}^{l}≦1. The upper bound X_{P}^{l}≦1 is implied by Equation 1.1 and, thus, can be eliminated from the formulation. In order to write the dual to the LP relaxation, associate dual variable π(l) with Equation 1.1 and dual variable δ(i,t) with Equation 1.2. The dual is:

$$\begin{matrix}min {\sum }_{𝓁}^{ } π ( 𝓁 ) + {\sum }_{i}^{ } {\sum }_{t}^{ } B ( i , t ) δ ( i , t ) , \\ where \text{:} & ( Eq . 2 ) \\ π ( 𝓁 ) \geq r ( 𝓁 ) - {\sum }_{i}^{ } {\sum }_{t ∈ T ( 𝓁 )}^{ } A ( 𝓁 , P , i , t ) δ ( i , t ) ∀ P ∈ {P}_{𝓁} , & ( Eq . 2.1 ) \\ π ( 𝓁 ) \geq 0 ( 𝓁 ) ∀ 𝓁 , \\ and & ( Eq . 2.2 ) \\ δ ( i , t ) \geq 0 ∀ i ∀ t . & ( Eq . 2.3 )\end{matrix}$$

Here, any feasible solution to the dual is an upper bound on the total revenue that can be generated. From Equation 2.1, dual variable π(l) may be specified as follows:

$$π ( 𝓁 ) = r ( 𝓁 ) - {min}_{P ∈ {P}_{𝓁}} {\sum }_{i}^{ } {\sum }_{t ∈ T ( 𝓁 )}^{ } A ( 𝓁 , P , i , t ) δ ( i , t ) . \qquad ( Eq . 3 )$$

In the above-described formulation of the resource allocation problem, it was assumed that information about all resource requests l is known a priori. In the resource allocation process performed by resource allocation system 140, however, information about all resource requests l is not known a priori. In the resource allocation process, the resource requests l arrive over time and may be handled when received. In the resource allocation process, the dual variables may be used to guide the resource allocation for a resource request l and, once the resource allocation is made for the resource request l, the resource request l generates associated revenue. In conjunction with the resource allocation process, it is possible to use the dual variables in order to determine an upper bound on the revenue that can be generated. These and other functions and capabilities of the resource allocation process may be better understood by way of reference to FIG. 2.

FIG. 2 depicts one embodiment of a method for determining resource allocations in response to resource requests in a distributed cloud system. It will be appreciated that, although primarily depicted and described as being performed serially, at least a portion of the steps of method 200 may be performed contemporaneously or in a different order than presented in FIG. 2.

At step 201, method 200 begins.

At step 210, a set of delta values is initialized. The set of delta values includes a delta value for each combination of resource i and time slot t. Namely, set δ(i,t)←0 for all i,t.

At step 220, a resource request l is received. The resource request l specifies the amount of resources requested in each time slot (which also may include identification of the type(s) of resources being requested), the duration T(l) for which the resources will be required, and, optionally, a set of constraints to be satisfied. The requested resources include one or more types of cloud resources (e.g., VMs, memory, or the like). The requested resources also may include one or more types of network resources (e.g., bandwidth or the like). The amount of resources i may include, for each type of resource being requested, the requested amount of the type of resource being requested (e.g., ten VMs, 1 GB of storage capacity, 1 Mbps of bandwidth between data centers, or the like). The duration T(l) for which the resources will be used may be specified in increments of the time slots t. The set of constraints may include one or more of the location(s) at which the requested resources i are to be provided (e.g., which may be specified as geographic locations or areas, identification of distributed data centers 120, or the like), interconnection requirements related to interconnection of the requested resources i at the specified location(s), latency requirements, or the like, as well as various combinations thereof. The locations of the resources may be specified in any suitable manner (e.g., via identification of specific data centers to be used, via identification of geographic locations (which may be specified at any suitable granularity) or geographic areas in which the requested resources are to be hosted, or the like, as well as various combinations thereof. The resource request l may include any other information which may be used to determine allocation of cloud resources or network resources.

At step 230, a set of feasible resource mappings Pₗ is determined for the resource request l. The set of feasible resource mappings Pₗ may include zero or more feasible resource mappings P for resource request l. In at least some embodiments, a feasible resource mapping P for resource request l may be determined based on the resource request l (e.g., amounts of resources, types of resources, one or more constraints, or the like) and characteristics of available resources which may be assigned to resource request l (e.g., characteristics of data centers, characteristics of network connectivity between data centers, or the like). In at least some embodiments, a feasible resource mapping P for resource request l may be determined based on one or more constraints. In at least some embodiments, a feasible resource mapping P for resource request l may be determined based on one or more objectives of the cloud provider (e.g., balancing the load, maximizing the revenue, or the like). In at least some embodiments, a potential resource mapping is determined to be a feasible resource mapping P for resource request l if there are cloud resources and network resources adequate to support the determined resource mapping P(l), and determined not to be feasible otherwise. In at least some embodiments, a potential resource mapping is determined to be a feasible resource mapping P for resource request l if A(l,P,i,t)≦B(i,t) for all i,t, and determined not to be feasible otherwise. This ensures that there are adequate resources available to support the feasible resource mapping P should the feasible resource mapping P be selected as the resource mapping P(l). In at least some embodiments, a potential resource mapping is determined to be a feasible resource mapping P for resource request l if there are cloud resources and network resources adequate to support the determined resource mapping P(l) while satisfying any specified constraints, and determined not to be feasible otherwise.

At step 240, a determination is made as to whether the set of feasible resource mappings Pₗ is empty or non-empty. If the set of feasible resource mappings Pₗ is empty (e.g., no feasible resource mapping P was identified for the resource request l), method 200 proceeds to step 260. If the set of feasible resource mappings Pₗ is non-empty (e.g., at least one feasible resource mapping P was identified for the resource request l), method 200 proceeds to step 280.

At step 250, a determination is made as to whether to relax one or more parameters related to determining a set of feasible resource mappings Pₗ for the resource request l. The parameters may include one or more of one or more characteristics of the resource request l (e.g., amount of resources, type(s) of resources, one or more constraints, or the like), one or more constraints (e.g., geographic constraints, temporal constraints, or the like), one or more objectives of the cloud provider (e.g., balancing the load, maximizing the revenue, or the like), or the like, as well as various combinations thereof. The determination is made as to whether to relax one or more parameters related to determining a set of feasible resource mappings Pₗ for the resource request l may be based on one or more of feedback of a user associated with the client device 110 for or from which the resource request l is received, feedback of a user associated with the cloud provider (e.g., for relaxing one or more objectives of the cloud provider), a threshold for limiting the number of times the parameters may be relaxed, or the like, as well as various combinations thereof. If a determination is made to relax one or more parameters related to determining a set of feasible resource mappings Pₗ for the resource request l, method 200 proceeds to step 260. If a determination is made not to relax one or more parameters related to determining a set of feasible resource mappings Pₗ for the resource request l, method 200 proceeds to step 270.

At step 260, one or more parameters related to determining a set of feasible resource mappings Pₗ for the resource request l is relaxed. From step 260, method 200 returns to step 230, at which point a set of feasible resource mappings Pₗ is determined for the resource request l based on the relaxed parameter(s) associated with the resource request l.

At step 270, the resource request l is rejected. The total revenue and delta values are not updated. From step 270, method 200 proceeds to step 290.

At step 280, a resource mapping P(l) is determined for resource request l. From step 280, method 200 proceeds to step 290.

The resource mappings P(l) for resource request l is selected from the set of feasible resource mappings Pₗ for the resource request l. In at least some embodiments, the one of the feasible resource mappings P selected as the resource mapping P(l) may be an optimal one of the feasible resource mappings P (e.g., a feasible resource mapping P that minimizes

$${\sum }_{t ∈ T ( 𝓁 )}^{ } {\sum }_{i}^{ } A ( 𝓁 , P , i , t ) δ ( i , t ) ) .$$

The resource mapping P(l) specifies a mapping of the requested resources i onto the cloud resources of the distributed data centers and the network resources of the communication networks used for communication between the cloud resources of the data centers (e.g., the service provider network supporting communications between the distributed data centers and the communication networks of the distributed data centers hosting the cloud resources).

In the case of cloud resources, the resource mapping P(l) may specify the location(s) of the cloud resources to be used to provide requested resources i. The location(s) may be specified at any suitable level of granularity. For example, the location(s) of the cloud resources may identify the distributed data center(s) to be used to provide the requested resources i, specific equipment within the distributed data center(s) to be used to provide the requested resources i (e.g., in terms of the specific racks, servers, server blades, or at any other suitable level of granularity), or the like. In this case, the resource mapping P(l) may specify any other cloud resources which may be used to provide requested resources i.

In the case of network resources, the resource mapping P(l) may specify one or more network paths to be used to provide requested resources i. In general, a network path to be used to provide requested resources i may be specified in any suitable manner (e.g., as a hop-by-hop specification of the path, as a pipe providing a certain amount of bandwidth between two locations, or the like, as well as various combinations thereof). In this case, the resource mapping P(l) may specify any other network resources which may be used to provide requested resources i.

The resource mapping P(l) also may specify the time slots during which the resources are to be provided.

The resource mapping P(l) also may specify any other information suitable for use in describing mapping of the requested resources to the actual resources of the distributed cloud system.

The acceptance of the resource mapping P(l) for resource request l results in updating of one or more variables of method 200. The total revenue R is updated using R→R+r(l). (e.g., revenue resulting from acceptance of the resource request l is added to the total revenue R before acceptance of resource request l). The delta value δ(i,t) is updated for all resources i and all time slots tεT(l). The delta value is updated as follows:

$$δ ( i , t ) ← δ ( r , t ) [ 1 + \frac{A ( 𝓁 , P , i , t )}{B ( i , t )} ] + α \frac{A ( 𝓁 , P , i , t )}{B ( i , t )} ∀ i , t ,$$

where α is a constant (α≧0) which may be tuned to improve performance. For example, a may be set to α=1/(e−1). or any other value suitable for providing required or desired performance.

The acceptance of the determined resource mapping P(l) results in initiation of one or more management functions. The acceptance of the determined resource mapping P(l) may be communicated to the requestor from which the resource request l was received. The acceptance of the determined resource mapping may trigger one or more actions for enabling provision of resources of the distributed cloud system based on determined resource mapping P(l) (e.g., for causing allocation of cloud resources to the requestor, for causing allocation of network resources to the requestor, or the like, as well as various combinations thereof). At step 290, a determination is made as to whether or not a next resource request l has been received. If a next resource request l has not been received, method 200 remains at step 290 pending arrival of a next resource request l. If a next resource request l has been received, method 200 returns to step 220 to begin processing of the next resource request l.

It will be appreciated that method 200 may continue to run in this manner for as long as necessary or desired.

It will be appreciated that, since future resource requests are generally not known a priori, the resource allocations made using method 200 are online in the sense that resource allocations are made without knowledge of any resource requests that arrive in the future. The method 200 may be configured such that the current resource allocation made in response to the current resource request is made in such a manner so as to permit acceptance of as many future resource requests as possible. In at least some embodiments, an analysis of differences between results obtained using such an online system and results which could have been obtained using an offline process may be used to improve resource allocations made in the future. The analysis may be a revenue-based analysis. A description of an exemplary embodiment for using revenue based analysis of the online and the offline versions of the process to improve the online version of the process follows.

Referring back to FIG. 1, it will be appreciated that the resource allocation system 140 also may be configured to determine an upper bound on the revenue at any point in time. First, for each resource request l that has been received, a resource mapping Pᵤ(l)εPₗ that minimizes

$${\sum }_{t ∈ T ( 𝓁 )}^{ } {\sum }_{i}^{ } A ( 𝓁 , P , i , t ) δ ( i , t )$$

is computed using the current dual weights. This computation is performed for each resource request l, regardless of whether the resource request l was accepted or rejected. It will be appreciated that, for each resource request l, the resource mapping Pᵤ(l) can be different from the resource mapping P(s) that was chosen for the resource request l. Next, the value of π(l) is computed as π(l)←r(l)−w(Pᵤ(l)), where w(Pᵤ(l) is the current weight of the mapping Pᵤ(l). Finally, the value of the upper bound on the revenue is computed as

$${\sum }_{𝓁}^{ } π ( 𝓁 ) + {\sum }_{i}^{ } {\sum }_{t}^{ } δ ( i , t ) .$$

It will be appreciated that the upper bound on the revenue is the maximum revenue that could have been achieved had all of the resource requests l been served in the optimal way given a priori knowledge of the resource requests l (e.g., the maximum revenue that could have been achieved if resource allocation program was run as an offline process after the resource requests l were received). The cloud provider may compare the upper bound on the revenue to the actual revenue that was achieved via execution of method 200 as the resource requests l were received and processed (e.g., the value of R associated with the final resource request l that was considered in the analysis) in order to determine the performance of the process. In at least some embodiments, the cloud provider may initiate one or more actions in response to a determination that the actual revenue fails to satisfy a required or desired value (e.g., less than the upper bound on the revenue by more than a threshold amount).

The operation of resource allocation system 140 in determining a resource allocation for a resource request may be better understood by considering an example in which each resource request l is a request for two groups of virtual machines (VMs) for T(l) time slots. The first group of VMs includes N₁(l) VMs that need to be instantiated at one of the set of S₁(l) locations and the second group of VMs includes N₂(l) VMs that need to be instantiated at one of the set of S₂(l) locations. Assume, for the sake of simplicity, that each VM requires one type of resource (e.g., computing resource). In addition, assume that a bandwidth of C(l) is needed between these two groups of VMs. In this example, the terms “resource” and “location” are used interchangeably. In this example, there are two types of resources involved (namely, the compute resource at the locations where the VMs are instantiated and the bandwidth resource between the groups of VMs). In this example, when the resource request l is received, the objective of the resource allocation system 140 is to determine the locations of the two groups of VMs and the path(s) interconnecting the two groups of VMs. In order to solve the allocation problem, two dummy nodes are created (namely, a node referred to as the super source SS and a node referred to as the super sink ST). The node SS is connected to each node iεS₁ using an arc of weight N₁(l)Σ_{tεT(l)}δ(i,t) and each node iεS₂ is connected to the node ST using an arc of weight N₂(l)Σ_{tεT(l)}δ(i,t), where the weight of link i in the network is C(l)Σ_{tεT(l)}δ(i,t). The locations of the VM groups and the bandwidth connecting the VM groups are determined by computing the shortest path from SS to ST. If there are sufficient cloud and network resource to accept the resource request l, then the resource request l is accepted and the generated revenue is incremented by r(l) (otherwise, the resource request l is rejected or re-evaluated for the possibility of accepting the request using a different allocation of resources). If the resource request l is accepted, the value of delta δ(i,t) is updated for all locations i and all time slots tεT(l). It will be appreciated that, at any point in time, the quality of the solution thus far may be evaluated by determining an upper bound on the revenue by computing the shortest path for every resource request l that is received (not just the ones accepted) and computing dual variable π(l). Then, the upper bound on the revenue may be computed as

$${\sum }_{𝓁}^{ } π ( 𝓁 ) + {\sum }_{i}^{ } {\sum }_{t}^{ } δ ( i , t ) .$$

The operation of resource allocation system 140 in determining a resource allocation for a resource request may be better understood by considering an example in which a resource request of a customer specifies that 10 VMs are needed in the New York City area (e.g., to serve customers in the New York area), 10 VMs are needed in the Chicago area (e.g., the location of a back-end database that will be accessed by the customers in the New York area), and a 50 Mbps guaranteed bandwidth pipe is needed between the VMs needed in the New York City area and the VMs needed in the Chicago area. In this example, assume that there are multiple distributed data centers in the New York area (e.g., in New York, New Jersey, and Connecticut) and multiple distributed data centers in the Chicago area (e.g., in Illinois, Michigan, and Wisconsin), and that there are many potential network paths between the various distributed data centers in the New York City and Chicago areas. The data centers each include respective amounts of cloud resources, some of which may already be assigned and some of which may be available for assignment. Similarly, the communication network supporting communication between the data centers includes network resources (some of which may already be assigned and some of which may be available for assignment) which may be used to support various network paths between the data centers. Based on the arrangement of the distributed cloud system, there are many potential ways in which the requested service may be instantiated. The process determines that there are multiple potential resource mappings that may be used to satisfy the resource request. For example, a first mapping may include assigning 10 VMs to the data center in New Jersey, assigning 10 VMs to the data center in Illinois, and reserving network resources sufficient to support 50 Mbps communications between the data center in New Jersey and the data center in Illinois. For example, a second mapping may include assigning 10 VMs to the data center in New York, assigning 10 VMs to the data center in Michigan, and reserving network resources sufficient to support 50 Mbps communications between the data center in New York and the data center in Michigan. The process may then select one of the potential resource mappings (e.g., one of the potential resource mappings identified as being optimal) for the received resource request. If processing of the resource request does not result in identification of any potential resource mappings, one or more of the constraints associated with the resource request may be relaxed and the process may be repeated in order to identify one or more potential resource mappings and select one of the one or more of the potential resource mappings as the resource mapping to be used for the resource request.

It will be appreciated that, although primarily depicted and described herein with respect to embodiments in which the provider of the distributed cloud system is a network service provider that has direct control over the cloud resources and the network resources (and, thus, can jointly allocate cloud resources in the distributed data centers and reserve resources in the communication network), in at least one embodiment the provider of the distributed cloud system may be an entity other than a network service provider. In at least one such embodiment, the provider of the distributed cloud system may interact with one or more network service providers to buy or lease network resources needed to support the distributed cloud system.

It will be appreciated that, although primarily depicted and described herein with respect to embodiments in which a minimum weight mapping problem is solved in order to determine the resource allocation for a resource request, in at least some embodiments a heuristic procedure may be used to determine the resource allocation for a resource request. A heuristic procedure may be used, for example, if the minimum weight mapping problem cannot be solved in polynomial time.

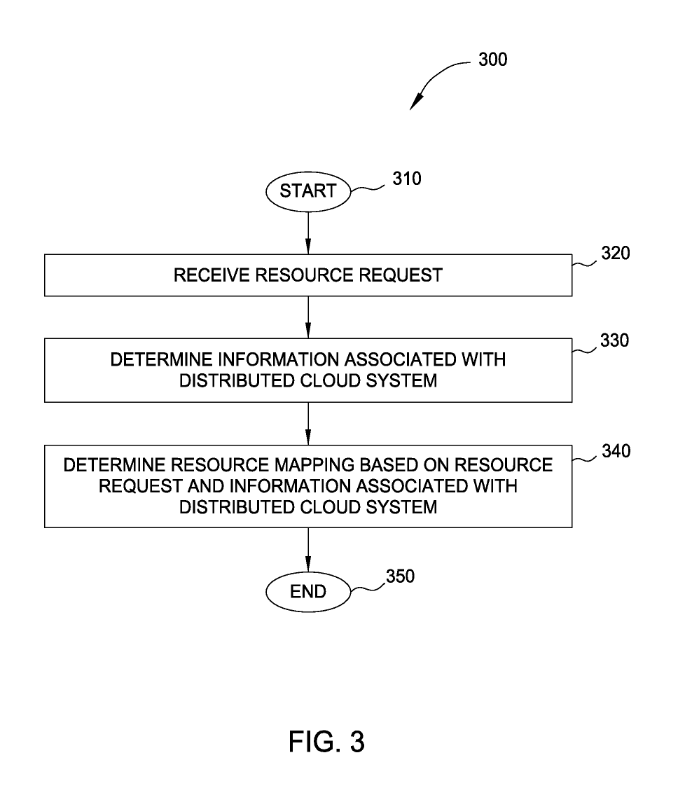

FIG. 3 depicts one embodiment of a method for determining a resource allocation in response to a resource request in a distributed cloud system.

At step 310, method 300 begins.

At step 320, a resource request is received. The resource request includes resource request information. The resource request information includes an indication of a request for cloud resources, an indication of a quantity of cloud resources requested, or the like. The resource request information also may include an indication of a request for network resources, an indication of a quantity of network resources requested, or the like. The resource request information also may include an indication of one or more geographic locations for the requested cloud resources. The resource request information also may include an indication of a duration of time for the cloud resources (e.g., the length of time for which use of the cloud resources is requested). The resource request information also may include one or more constraints (e.g., one or more of a geographic location constraint, a data center interconnection constraint, a latency constraint, or the like). It will be appreciated that any of the resource request information may be considered to be a constraint or constraints as such information may constrain the allocation of resources in response to the resource request. It also will be appreciated that, although primarily depicted and described with respect to embodiments in which the resource request information is included within the resource request, some or all of the resource request information may be provided or otherwise obtained independent of the resource request.

At step 330, information associated with the distributed cloud system is determined. The information associated with the distributed cloud system may include one or more of indications of cloud resources and network resources available at each of at least a portion of the distributed data centers, indications of network resources of a communication network that are available to support communications between ones of the distributed data centers, or the like, as well as various combinations thereof.

At step 340, a resource mapping is determined for the resource request based on the resource request and the information associated with the distributed cloud system. The resource mapping includes a mapping of the requested cloud resources to cloud resources of one or more of the data centers and an identification of network resources configured to support communications for the cloud resources of the one or more data centers.

At step 350, method 300 ends.

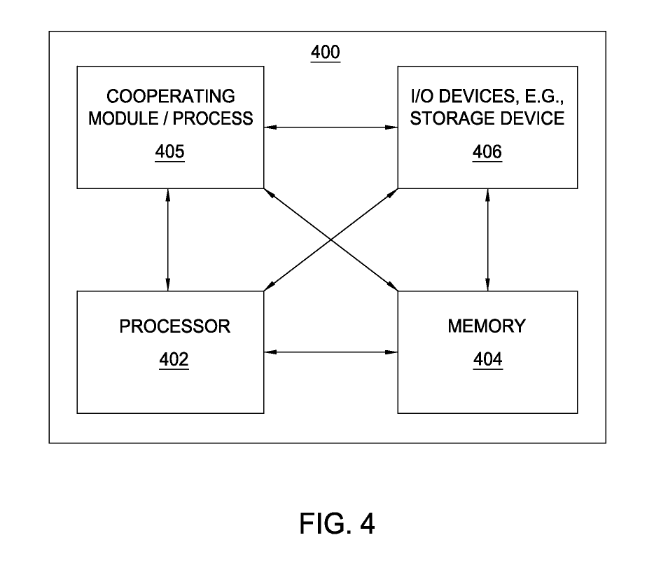

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 400 depicted in FIG. 4 provides a general architecture and functionality suitable for implementing functional elements described herein and/or portions of functional elements described herein. For example, the computer 400 provides a general architecture and functionality suitable for implementing one or more of a client device 110, a portion of a client device 110, one or more elements of a distributed data center 120, one or more cloud resources 122 of a distributed data center 120, one or more elements of communication network 130, one or more network resources 131 of communication network 130, resource allocation system 140, a portion of resource allocation system 140, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus for processing a request for resources of a distributed cloud system including a plurality of data centers, comprising:
a processor and a memory communicatively connected to the processor, the processor configured to:
receive a request for resources of the distributed cloud system, wherein the request for resources comprises a request for cloud resources and an indication of an amount of cloud resources requested; and
determine a resource mapping for the resource request based on the request for resources and information associated with the distributed cloud system, the resource mapping comprising a mapping of the requested cloud resources to cloud resources of one or more of the data centers and an identification of network resources configured to support communications for the cloud resources of the one or more data centers.

2. The apparatus of claim 1, wherein the request for resources comprises an indication of one or more geographic locations for the requested cloud resources.

3. The apparatus of claim 1, wherein the request for resources comprises a request for network resources and an indication of an amount of network resources requested.

4. The apparatus of claim 1, wherein the request for resources comprises an indication of a duration of time for the cloud resources.

5. The apparatus of claim 1, wherein the request for resources comprises one or more constraints.

6. The apparatus of claim 5, wherein the one or more constraints comprises one or more of a geographic location constraint, a data center interconnection constraint, or a latency constraint.

7. The apparatus of claim 1, wherein the information associated with the distributed cloud system comprises:
for each of at least one of the data centers of the distributed cloud system, an indication of cloud resources available at the data center and an indication of network resources available at the data center.

8. The apparatus of claim 1, wherein the information associated with the distributed cloud system comprises:
for a communication network configured to support communications between at least a portion of the data centers of the distributed cloud system, an indication of network resources of the communication network available to support communications between ones of the data centers of the distributed cloud system.

9. The apparatus of claim 1, wherein the information associated with the distributed cloud system comprises:
for each of at least one pair of data centers of the distributed cloud system, an indication of network resources between the data centers in the pair of data centers.

10. The apparatus of claim 1, wherein the network resources configured to support communications for the cloud resources of the one or more data centers comprise:
network resources of the one or more data centers; and
network resources of a communication network configured to support communications between at least one device and at least one of the one or more data centers.

11. The apparatus of claim 1, wherein the resource mapping comprises a mapping of the requested cloud resources to cloud resources of two or more of the data centers, wherein the network resources configured to support communications for the cloud resources of the two or more data centers comprise network resources of a communication network configured to support communications between the two or more data centers.

12. The apparatus of claim 1, wherein the request for resources comprises a first geographic location and a second geographic location, wherein the processor is configured to determine the resource mapping by:
identifying one or more of the data centers associated with the first geographic location, and selecting one of the one or more of the data centers associated with the first geographic location;
identifying one or more of the data centers associated with the second geographic location, and selecting one of the one or more of the data centers associated with the second geographic location; and
identifying at least one network resource configured to support communication between the selected one of the data centers associated with the first geographic location and the selected one of the data centers associated with the second geographic location.

13. The apparatus of claim 1, wherein the processor is configured to determine the resource mapping by:
determining a set of feasible resource mappings based on the request for resources and the information associated with the distributed cloud system.

14. The apparatus of claim 13, wherein the processor is configured to determine the resource mapping by:
determining whether to relax at least one parameter associated with the request for resources based on a determination that the set of feasible resource mappings is empty.

15. The apparatus of claim 13, wherein the processor is configured to determine the resource mapping by:
selecting a feasible resource mapping from the set of feasible resource mappings based on a determination that the set of feasible resource mappings includes a plurality of feasible resource mappings.

16. The apparatus of claim 15, wherein the selected one of the feasible resource mappings is one of the feasible resource mappings that minimizes
$${\sum }_{t ∈ T ( 𝓁 )}^{ } {\sum }_{i}^{ } A ( 𝓁 , P , i , t ) δ ( i , t )$$
wherein:
A(l,P,i,t) represent an amount of resources i consumed in time slot t when feasible resource mapping P is used for the resource request l; and
δ(i,t) is a delta value configured to track amounts of resources available at respective locations.

17. The apparatus of claim 16, wherein the processor is configured to:
based on a determination that the resource request is accepted based on the selected one of the feasible resource mappings, update the delta value based on:
$$δ ( i , t ) ← δ ( r , t ) [ 1 + \frac{A ( 𝓁 , P , i , t )}{B ( i , t )} ] + α \frac{A ( 𝓁 , P , i , t )}{B ( i , t )} ∀ i , t ,$$
wherein B(i,t) represents an amount of resource i available in time slot t and α is a tunable constant.

18. The apparatus of claim 12, wherein the set of feasible resource mappings is determined from a set of potential resource mappings, wherein the processor is configured to: determine whether a potential resource mapping is a feasible resource mapping given available cloud resources of the distributed data centers and available network resources by evaluating A(l,P,i,t)≦B(i,t) for i,t, wherein:
A(l,P,i,t) represent an amount of resources i consumed in time slot t when resource mapping P is used for the resource request l; and
B(i,t) represents an amount of resource i available in time slot t.

19. A computer-readable storage medium storing instructions which, when executed by a computer, cause the computer to perform a method for processing a request for resources of a distributed cloud system including a plurality of data centers, the method comprising:
receiving a request for resources of the distributed cloud system, wherein the request for resources comprises a request for cloud resources and an indication of an amount of cloud resources requested; and
determining a resource mapping for the request for resources based on the request for resources and information associated with the distributed cloud system, the resource mapping comprising a mapping of the requested cloud resources to cloud resources of one or more of the data centers and an identification of network resources configured to support communications for the cloud resources of the one or more data centers.

20. A method for processing a request for resources of a distributed cloud system including a plurality of data centers, comprising:
using a processor for:
receiving a request for resources of the distributed cloud system, wherein the request for resources comprises a request for cloud resources and an indication of an amount of cloud resources requested; and
determining a resource mapping for the request for resources based on the request for resources and information associated with the distributed cloud system, the resource mapping comprising a mapping of the requested cloud resources to cloud resources of one or more of the data centers and an identification of network resources configured to support communications for the cloud resources of the one or more data centers.
